(19) United States
(12) Patent Application Publication
(10) Pub. No.: US 2018/0239987 A1
(43) Pub. Date: Aug. 23, 2018

(54) IMAGE RECOGNITION METHOD AND APPARATUS

(71) Applicant: Alibaba Group Holding Limited, Georgetown (KY)

(72) Inventor: Kai CHEN, Hangzhou (CN)

(21) Appl. No.: 15/900,186

(22) Filed: Feb. 20, 2018

(30) Foreign Application Priority Data
Feb. 22, 2017 (CN) 201710097375.8

(51) Int. Cl. G06K 9/62; G06K 9/32

(52) U.S. Cl. CPC G06K 9/6262; G06K 9/3275

(57) ABSTRACT

An image recognition method and apparatus. The method comprises: carrying out image processing and spatial transformation processing on a to-be-recognized image based on a spatial transformer network model, so as to obtain a reproduced image probability value corresponding to the to-be-recognized image; and determining the to-be-recognized image as a suspected reproduced image when it is judged that the reproduced image probability value corresponding to the to-be-recognized image is greater than or equal to a preset first threshold. By means this method, a spatial transformer network model can be established by merely carrying out one model training and model testing on a spatial transformer network. The method reduces the workload for calibrating image samples during training and testing and further enhances training and testing efficiencies. Further, the model training is carried out based on a one-level spatial transformer network, and configuration parameters obtained from the training form an optimal combination, thereby improving the recognition function when using the spatial transformer network model to recognize an image online.

### CROSS REFERENCE TO RELATED APPLICATIONS

This application claims priority to China Patent Application No. 201710097375.8, filed on Feb. 22, 2017, which is incorporated herein by reference in its entirety.

### TECHNICAL FIELD

The present invention relates to the field of image recognition technologies, and in particular, to an image recognition method and apparatus.

### BACKGROUND

With the development of Internet economy, e-commerce platforms provide users great convenience in shopping and transaction. In the e-commerce ecology, “money” is involved in almost every step, and this somehow gives rise to the following phenomenon: lawbreakers carry out illegal and irregular actions such as cheating and releasing information of prohibited goods on e-commerce platforms by using fake identities. It is thus desirable to construct a honest and credible system for society by using “real-person authentication” to promote a healthy ecological environment on the Internet.

Real-person authentication aims to make sure that real persons and their identity cards match. A person using an account can be identified conveniently and accurately according to authenticated account identity information. During the implementation of real-person authentication, it has been found that identity card images uploaded by some users during real-person authentication are reproduced images. It is very likely that these users illegally acquire use data of identity cards of others. During a real-person authentication process, it is therefore necessary to carry out recognition and classification on identity card images uploaded by users, and to judge whether the identity card images uploaded by the users are reproduced images.

In the prior art, during a real-person authentication process, it is necessary to carry out detection and judgment processing on user-uploaded identity card images by using multistage independent convolutional neural networks (CNNs).

However, in the prior art, a corresponding training model needs to be established for each CNN, and training of a huge number of samples is required, thus causing a heavy workload of sample calibration. Moreover, a lot of human and material resources need to be used for subsequent operations and maintenances on the established multiple CNNs. Further, in the prior art, the identity card images uploaded by the users are recognized by using multistage independent CNNs processing, and the recognition effect is poor.

In view of the above, it is necessary and desirable to design a new image recognition method and apparatus to solve the problems and overcome disadvantages found in the prior art.

### SUMMARY

Embodiments of the present invention provide an image recognition method and apparatus, so as to solve the problems in the prior art including the heavy workload of sample calibration caused by training of a huge number of samples carried out for each CNN, and poor image recognition effect caused by using of the multistage independent CNNs for processing.

Specific technical solutions provided in embodiments of the present invention are as follows: An image recognition method, comprising: inputting an acquired to-be-recognized image to a spatial transformer network model; carrying out image processing and spatial transformation processing on the to-be-recognized image based on the spatial transformer network model so as to obtain a reproduced image probability value corresponding to the to-be-recognized image; and determining the to-be-recognized image as a suspected reproduced image when it is judged that the reproduced image probability value corresponding to the to-be-recognized image is greater than or equal to a preset first threshold.

In an embodiment, before the step of inputting an acquired to-be-recognized image to a spatial transformer network model, the method further comprises: acquiring image samples and dividing the acquired image samples into a training set and a testing set according to a preset ratio; and constructing a spatial transformer network based on a convolutional neural network (CNN) and a spatial transformer module, carrying out a model training on the spatial transformer network based on the training set, and carrying out a model testing on the spatial transformer network having finished the model training based on the testing set.

In an embodiment, the step of constructing a spatial transformer network based on a CNN and a spatial transformer module comprises: embedding a learnable spatial transformer module in the CNN to construct a spatial transformer network, wherein the spatial transformer module comprises at least a positioning network, a grid generator, and a sampler, the positioning network comprising at least one convolutional layer, at least one pooling layer, and at least one fully connected layer, wherein the positioning network is configured to generate a transformation parameter set; the grid generator is configured to generate sampling grids according to the transformation parameter set; and the sampler is configured to sample the input image according to the sampling grids.

In an embodiment, the step of carrying out a model training on the spatial transformer network based on the training set comprises: dividing the image samples comprised in the training set into several batches based on the spatial transformer network, wherein one batch comprises G image samples, and G is a positive integer greater than or equal to 1; and sequentially performing the following operations for each batch comprised in the training set until it is judged that all recognition accuracy rates corresponding to Q successive batches are greater than a first preset threshold, determining that the model training carried out on the spatial transformer network is finished, and Q is a positive integer greater than or equal to 1; carrying out spatial transformation processing and image processing on each image sample comprised in one batch by using current configuration parameters and obtain a corresponding recognition result, wherein the configuration parameters at least comprise a parameter used by at least one convolutional layer, a parameter used by at least one pooling layer, a parameter used by at least one fully connected layer, and a parameter used by the spatial transformer module; calculating a recognition accuracy rate corresponding to the one batch based on recognition results of the image samples comprised in the one batch; and determining whether the recognition accuracy rate corresponding to the one batch is greater than the first preset threshold; and if so, keeping the current configuration parameters unchanged; otherwise, adjusting the current configuration parameters, and using the adjusted configuration parameters as current configuration parameters used for a next batch.

In an embodiment, the step of carrying out a model testing on the spatial transformer network having finished the model training based on the testing set comprises: carrying out image processing and spatial transformation processing on each image sample comprised in the testing set based on the spatial transformer network having finished the model training and obtaining a corresponding output result, wherein the output result comprises a reproduced image probability value and a non-reproduced image probability value corresponding to each image sample; and setting the first threshold based on the output result, thereby determining that the model testing on the spatial transformer network is finished.

In an embodiment, the step of setting the first threshold based on the output result comprises: using a respectively reproducing probability value of each image sample comprised in the testing set as a set threshold, and determining a false positive rate (FPR) and a true positive rate (TPR) corresponding to each set threshold based on the reproduced image probability value and the non-reproduced image probability value corresponding to each image sample comprised in the output result; drawing a receiver operating characteristic (ROC) curve based on the determined FPR and TPR corresponding to each set threshold, the ROC curve using the FPR as an X-axis and the TPR as a Y-axis; and setting a reproduced image probability value corresponding to the FPR equaling to a second preset threshold as the first threshold based on the ROC curve.

In an embodiment, the step of carrying out image processing on the to-be-recognized image based on the spatial transformer network model comprises: carrying out convolution processing at least once, pooling processing at least once, and full connection processing at least once on the to-be-recognized image based on the spatial transformer network model.

In an embodiment, the step of carrying out spatial transformation processing on the to-be-recognized image comprises: the spatial transformer network model comprising at least the CNN and the spatial transformer module, and the spatial transformer module comprising at least the positioning network, the grid generator, and the sampler, after any convolution processing is carried out on the to-be-recognized image by using the CNN, generating the transformation parameter set by using the positioning network; generating the sampling grids by using the grid generator according to the transformation parameter set; and carrying out sampling and spatial transformation processing on the to-be-recognized image by using the sampler according to the sampling grids, wherein the spatial transformation processing comprises at least any one or a combination of the following operations: rotation processing, translation processing, and scaling processing.

In an embodiment, the present image recognition method, comprises: receiving a to-be-recognized image uploaded by a user, carrying out image processing on the to-be-recognized image when an image processing instruction triggered by the user is received; carrying out spatial transformation processing on the to-be-recognized image when a spatial transformation instruction triggered by the user is received; and presenting to the user the to-be-recognized image after the image has gone through the image processing and the spatial transformation processing; calculating a reproduced image probability value corresponding to the to-be-recognized image according to a user instruction; and judging whether the reproduced image probability value corresponding to the to-be-recognized image is less than a preset first threshold; and if so, determining the to-be-recognized image as a non-reproduced image, and prompting the user that the recognition is successful; otherwise, determining the to-be-recognized image as a suspected reproduced image.

In an embodiment, after the step of determining the to-be-recognized image as a suspected reproduced image, the method further comprises: presenting the suspected reproduced image to an administrator, and prompting the administrator to review the suspected reproduced image; and determining whether the suspected reproduced image is a reproduced image according to a review feedback of the administrator.

In an embodiment, the step of carrying out image processing on the to-be-recognized image comprises: carrying out convolution processing at least once, pooling processing at least once, and full connection processing at least once on the to-be-recognized image.

In an embodiment, the step of carrying out spatial transformation processing on the to-be-recognized image comprises: carrying out any one or a combination of the following operations on the to-be-recognized image: rotation processing, translation processing, and scaling processing.

In another embodiment, the present image processing apparatus comprises: an input unit, configured to input an acquired to-be-recognized image to a spatial transformer network model; a processing unit, configured to carry out image processing and spatial transformation processing on the to-be-recognized image based on the spatial transformer network model so as to obtain a reproduced image probability value corresponding to the to-be-recognized image; and a determination unit, configured to determine the to-be-recognized image as a suspected reproduced image when it is judged that the reproduced image probability value corresponding to the to-be-recognized image is greater than or equal to a preset first threshold.

In an embodiment, before an acquired to-be-recognized image is inputted to a spatial transformer network model, the input unit is further configured to: acquire image samples and divide the acquired image samples into a training set and a testing set according to a preset ratio; and construct a spatial transformer network based on a convolutional neural network (CNN) and a spatial transformer module; carry out a model training on the spatial transformer network based on the training set; and carry out a model testing on the spatial transformer network having finished the model training based on the testing set.

In an embodiment, when constructing a spatial transformer network based on a CNN and a spatial transformer module, the input unit is configured to: embed a learnable spatial transformer module in the CNN to construct a spatial transformer network, wherein the spatial transformer module comprises at least a positioning network, a grid generator, and a sampler, the positioning network comprising at least one convolutional layer, at least one pooling layer, and at least one fully connected layer, wherein the positioning network is configured to generate a transformation parameter set; the grid generator is configured to generate sampling grids according to the transformation parameter set; and the sampler is configured to sample the input image according to the sampling grids.

In an embodiment, when carrying out model training on the spatial transformer network based on the training set, the input unit is configured to: divide the image samples comprised in the training set into several batches based on the spatial transformer network, wherein one batch comprises G image samples, and G is a positive integer greater than or equal to 1; and sequentially perform the following operations for each batch comprised in the training set until it is judged that all recognition accuracy rates corresponding to Q successive batches are greater than a first preset threshold, determine that the model training carried out on the spatial transformer network is finished, and Q is a positive integer greater than or equal to 1; carry out spatial transformation processing and image processing on each image sample comprised in one batch by using current configuration parameters and obtain a corresponding recognition result, wherein the configuration parameters comprise at least a parameter used by at least one convolutional layer, a parameter used by at least one pooling layer, a parameter used by at least one fully connected layer, and a parameter used by the spatial transformer module; calculate a recognition accuracy rate corresponding to the one batch based on recognition results of the image samples comprised in the one batch; and judge whether the recognition accuracy rate corresponding to the one batch is greater than the first preset threshold; and if so, keep the current configuration parameters unchanged; otherwise, adjust the current configuration parameters, and use the adjusted configuration parameters as current configuration parameters used for a next batch.

In an embodiment, when carrying out a model testing on the spatial transformer network having finished the model training based on the testing set, the input unit is configured to: carry out image processing and spatial transformation processing on each image sample comprised in the testing set based on the spatial transformer network having finished the model training and obtain a corresponding output result, wherein the output result comprises a reproduced image probability value and a non-reproduced image probability value corresponding to each image sample; and set the first threshold based on the output result, thereby determining that the model testing on the spatial transformer network is finished.

In an embodiment, when setting the first threshold based on the output result, the input unit is configured to: use a respective reproducing probability value of each image sample comprised in the testing set as a set threshold; and determine a false positive rate (FPR) and a true positive rate (TPR) corresponding to each set threshold based on the reproduced image probability value and the non-reproduced image probability value corresponding to each image sample comprised in the output result; draw a receiver operating characteristic (ROC) curve based on the determined FPR and TPR corresponding to each set threshold, the ROC curve using the FPR as an X-axis and the TPR as a Y-axis; and set a reproduced image probability value corresponding to the FPR equaling to a second preset threshold as the first threshold based on the ROC curve.

In an embodiment, when carrying out image processing on the to-be-recognized image based on the spatial transformer network model, the input unit is configured to: carry out convolution processing at least once, pooling processing at least once, and full connection processing at least once on the to-be-recognized image based on the spatial transformer network model.

In an embodiment, when carrying out spatial transformation processing on the to-be-recognized image, the input unit is configured to: the spatial transformer network model comprising at least the CNN and the spatial transformer module, and the spatial transformer module comprising at least the positioning network, the grid generator, and the sampler; after any convolution processing is carried out on the to-be-recognized image by using the CNN, generate the transformation parameter set by using the positioning network; generate the sampling grids by using the grid generator according to the transformation parameter set; and carry out sampling and spatial transformation processing on the to-be-recognized image by using the sampler according to the sampling grids, wherein the spatial transformation processing comprises at least any one or a combination of the following operations: rotation processing, translation processing, and scaling processing.

In another embodiment, the present image recognition apparatus comprises: a receiving unit, configured to receive a to-be-recognized image uploaded by a user; a processing unit, configured to carry out image processing on the to-be-recognized image when an image processing instruction triggered by the user is received; carry out spatial transformation processing on the to-be-recognized image when a spatial transformation instruction triggered by the user is received; and present to the user the to-be-recognized image after the image has gone through the image processing and the spatial transformation; a calculation unit, configured to calculate a reproduced image probability value corresponding to the to-be-recognized image according to a user instruction; and a judging unit, configured to judge whether the reproduced image probability value corresponding to the to-be-recognized image is less than a preset first threshold; and if so, determine the to-be-recognized image as a non-reproduced image, and prompt the user that the recognition is successful; otherwise, determine the to-be-recognized image as a suspected reproduced image.

In an embodiment, after the to-be-recognized image is determined as a suspected reproduced image, the judging unit is further configured to: present the suspected reproduced image to an administrator, and prompt the administrator to review the suspected reproduced image; and determine whether the suspected reproduced image is a reproduced image according to a review feedback of the administrator.

In an embodiment, when carrying out image processing on the to-be-recognized image, the processing unit is configured to: carry out convolution processing at least once, pooling processing at least once, and full connection processing at least once on the to-be-recognized image.

In an embodiment, when carrying out spatial transformation processing on the to-be-recognized image, the processing unit is configured to: carry out any one or a combination of the following operations on the to-be-recognized image: rotation processing, translation processing, and scaling processing.

The present invention has the following beneficial effects: in view of the above, in embodiments of the present invention, during image recognition based on a spatial transformer network model, an acquired to-be-recognized image is input to the spatial transformer network model, image processing and spatial transformation processing are carried out on the to-be-recognized image based on the spatial transformer network model so as to obtain a reproduced image probability value corresponding to the to-be-recognized image, and the to-be-recognized image is determined as a suspected reproduced image when it is judged that the reproduced image probability value corresponding to the to-be-recognized image is greater than or equal to a preset first threshold. By means of the image recognition method, a spatial transformer network model can be established by carrying out model training and model testing for a spatial transformer network only once. In this way, the workload for calibrating image samples during training and testing is reduced, and training and testing efficiencies are improved. Further, the model training is carried out based on a one-level spatial transformer network, and configuration parameters obtained by the training form an optimal combination, thereby improving the recognition effect when an image is recognized by using the spatial transformer network model online.

### BRIEF DESCRIPTION OF THE DRAWINGS

FIG. 1 is a detailed flowchart of carrying out model training based on the established spatial transformer network according to an embodiment of the present invention;

FIG. 2 is a schematic structural diagram of a spatial transformer according to an embodiment of the present invention;

FIG. 3 is a schematic diagram of carrying out spatial transformation on image samples based on a spatial transformer according to an embodiment of the present invention;

FIG. 4 is a schematic diagram of converting three input neurons into two output neurons by carrying out dimensionality reduction processing using a fully connected layer according to an embodiment of the present invention;

FIG. 5 is a detailed flowchart of carrying out model testing on a spatial transformer network based on the testing set according to an embodiment of the present invention;

FIG. 6 is a schematic diagram of drawing an ROC curve according to 10 groups of different FPRs and TPRs according to an embodiment of the present invention, the ROC curve using the FPR as an X-axis and the TPR as a Y-axis;

FIG. 7 is a detailed flowchart of carrying out image recognition by using a spatial transformer network model online according to an embodiment of the present invention;

FIG. 8 is a detailed flowchart of carrying out image recognition processing on a to-be-recognized image uploaded by a user in an actual business scenario according to an embodiment of the present invention;

FIG. 9 is a schematic structural diagram of an image processing apparatus according to an embodiment of the present invention; and

FIG. 10 is a schematic structural diagram of another image processing apparatus according to an embodiment of the present invention.

### DETAILED DESCRIPTION

In the prior art, during a real-person authentication process, a process of carrying out detection and judgment on an identity card image uploaded by a user includes: first carrying out rotation correction by using a first CNN on the identity card image uploaded by the user; then capturing an identity card region from the rotation corrected identity card image by using a second CNN; and finally carrying out classification and recognition on the captured identity card image by using a third CNN. That is, in the prior art, it is required to sequentially carry out CNN rotation angle processing once, CNN identity card region capturing processing once, and CNN classification processing once. In this way, three CNNs need to be established. A corresponding training model needs to be established for each CNN, and training of a huge number of samples is required, thus causing a heavy workload of sample calibration. Moreover, a lot of human and material resources need to be used for subsequent operations and maintenances on the established three CNNs. Further, in the prior art, the identity card images uploaded by the users are recognized by using multistage independent CNNs processing, and the recognition effect is poor.

A new image recognition method and apparatus are designed in accordance with embodiments of the present invention to solve the problems in the prior art including the heavy workload of sample calibration caused by training of a huge number of samples carried out for each CNN, and poor image recognition effect caused by using of the multistage independent CNNs for processing. The method includes: inputting an acquired to-be-recognized image to a spatial transformer network model; carrying out image processing and spatial transformation processing on the to-be-recognized image based on the spatial transformer network model so as to obtain a reproduced image probability value corresponding to the to-be-recognized image; and determining the to-be-recognized image as a suspected reproduced image when it is judged that the reproduced image probability value corresponding to the to-be-recognized image is greater than or equal to a preset first threshold.

The technical solutions in embodiments of the present invention will be described clearly and completely in the following with reference to the accompanying drawings in embodiments of the present invention. As can be appreciated, the described embodiments are merely a part of; rather than all embodiments of the present invention. All other embodiments obtained by those of ordinary skill in the art based on embodiments in the present invention efforts fall within the protection scope of the present invention.

The present invention will be described in detail through embodiments in the following. It should be noted that the present invention is not limited to the following embodiments.

In embodiments of the present invention, before image recognition is carried out, existing convolutional neural networks (CNNs) need to be improved. That is, a learnable spatial transformer module is introduced into the existing convolutional neural network, to establish a spatial transformer network. In this way, the spatial transformer network can actively carry out spatial transformation processing on image data inputted to the spatial transformer network. The spatial transformer module includes a positioning network, a grid generator, and a sampler. The convolutional neural network includes at least one convolutional layer, at least one pooling layer, and at least one fully connected layer. The positioning network in the spatial transformer also includes at least one convolutional layer, at least one pooling layer, and at least one fully connected layer. The spatial transformer module in the spatial transformer network may be inserted behind any convolutional layer.

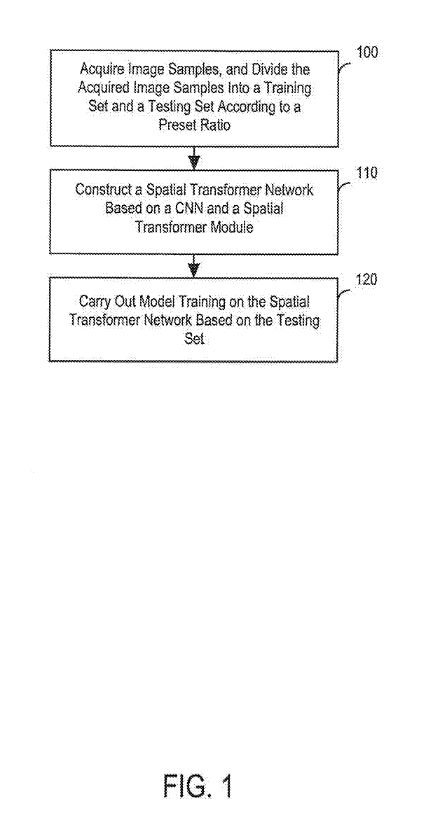

Please refer to FIG. 1. A detailed procedure of carrying out model training based on the established spatial transformer network according to an embodiment of the present invention is described as follows:

Step 100: Image samples are acquired, and the acquired image samples are divided into a training set and a testing set according to a preset ratio.

In an embodiment, collection of image samples is a very important step and also a burdensome task for the spatial transformer network. The image samples may be confirmed reproduced identity card images and confirmed non-reproduced identity card images. It goes without saying that the image samples may also be other types of images, e.g., confirmed animal images and confirmed plant images, confirmed images with texts and confirmed images without texts, and so on.

In an embodiment of the present invention, images of the front and the back of an identity card are used as image samples, the images being submitted by a registered user of an e-commerce platform when carrying out real-person authentication.

In an embodiment, the so-called reproduced image sample refers to a picture on a computer screen, a picture on a mobile phone screen, a copy of a picture, or the like reproduced by using a terminal. Therefore, the reproduced image sample includes at least a reproduced image of a computer screen, a reproduced image of a mobile phone screen, and a reproduced image of a copy. Assuming that in an acquired image sample set, half of the image samples are confirmed reproduced image sample and the other half are confirmed non-reproduced image samples. The acquired image sample set is divided into a training set and a testing set according to a preset ratio. The image samples included in the training set are used for subsequent model training. The image samples included in the testing set are used for subsequent model testing.

For example, assuming that in an embodiment of the present invention, one hundred thousand confirmed reproduced identity card images and one hundred thousand confirmed non-reproduced identity card images are collected in the acquired image sample set. Then, the one hundred thousand confirmed reproduced identity card images and the one hundred thousand confirmed non-reproduced identity card images may be divided into a training set and a testing set according to a ration, i.e., 10:1.

Step 110: A spatial transformer network is constructed based on a CNN and a spatial transformer module.

A network structure of the spatial transformer network used in embodiments of the present invention includes at least the CNN and the spatial transformer module. That is, a learnable spatial transformer module is introduced into the CNN. A network structure of the CNN includes at least one convolutional layer, at least one pooling layer, and at least one fully connected layer. The last layer is the fully connected layer. The spatial transformer network is formed by embedding a spatial transformer module behind any convolutional layer in a CNN. The spatial transformer network can actively carry out a spatial transformation operation on image data input to the network. The spatial transformer module includes at least a positioning network, a grid generator, and a sampler. A network structure of the positioning network in the spatial transformer network also includes at least one convolutional layer, at least one pooling layer, and at least one fully connected layer. The positioning network is configured to generate a transformation parameter set; the grid generator is configured to generate sampling grids according to the transformation parameter set; and the sampler is configured to sample the input image according to the sampling grids.

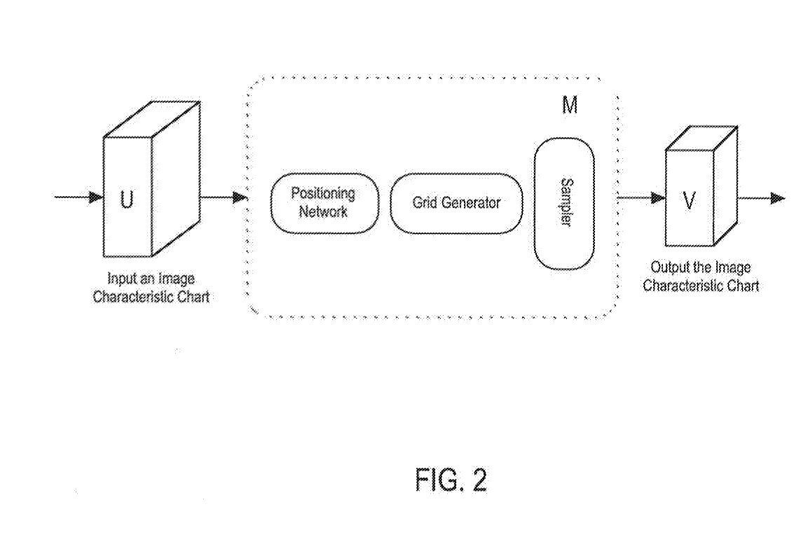

FIG. 2 illustrates a schematic structural diagram of the spatial transformer, in an embodiment of the invention. If U∈R^{H×W×C}, an input image characteristic chart, for example, an original image or an image characteristic chart outputted by a convolutional layer of the CNN, wherein W is the width of the image characteristic chart; H is the height of the image characteristic chart; C is the number of channels; V is an output image characteristic chart after spatial transformation is carried out on U by using the spatial transformer module; and M is between U and V is the spatial transformer. The spatial transformer includes at least a positioning network, a gird generator, and a sampler.

The positioning network in the spatial transformer module may be configured to generate a transformation parameter θ. Preferably, the parameter θ includes six parameters of affine transformation such as a translation transformation parameter, a scale transformation parameter, a rotation transformation parameter, and a shear transformation parameter, wherein the parameter θ may be denoted as θ=f_{loc}(U).

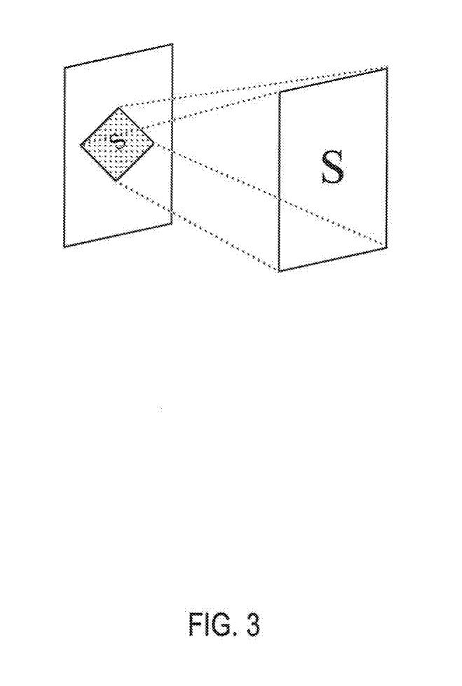

Please refer to FIG. 3. The grid generator in the spatial transformer may be configured to utilize the parameter θ generated by the positioning network and V; that is, calculate to obtain a position of each point in V corresponding to U by using the parameter θ; and obtain V by sampling from U. A specific calculation formula is shown as follows:

$$( \begin{matrix}{x}_{i}^{s} \\ {y}_{i}^{s}\end{matrix} ) = {τ}_{θ} ( {G}_{i} ) = {A}_{θ} = ( \begin{matrix}{x}_{i}^{t} \\ {y}_{i}^{t} \\ 1\end{matrix} ) = [ \begin{matrix}{θ}_{11} & {θ}_{12} & {θ}_{13} \\ {θ}_{21} & {θ}_{22} & {θ}_{23}\end{matrix} ] ( \begin{matrix}{x}_{i}^{t} \\ {y}_{i}^{t} \\ 1\end{matrix} ) ,$$

wherein (xᵢ^{t},yᵢ^{t}) is a coordinate position of a point in U; and (xᵢ^{s},yᵢ^{s}) is a coordinate position of a point in V.

After the sampling grids are generated, the sampler in the spatial transformer may obtain V from U by sampling.

The spatial transformer network includes the CNN and the spatial transformer. The spatial transformer further includes the positioning network, the grid generator, and the sampler. The CNN includes at least one convolutional layer, at least one pooling layer, and at least one fully connected layer. The positioning network in the spatial transformer network also includes at least one convolutional layer, at least one pooling layer, and at least one fully connected layer.

In an embodiment of the present invention, con[N,w,sl,p] is used to denote a convolutional layer, wherein N is the number of channels, w*w is the size of a convolution kernel, sl is a step length corresponding to each channel, and p is a padding value. The convolutional layer may be used for extracting image characteristics of an input image. Convolution is a commonly used method of image processing. Each pixel in an output image of the convolutional layer is a weighted average of pixels in a small region of the input image, wherein a weight is defined by a function, and the function is referred to as a convolution kernel. The convolution kernel is a function, and each parameter in the convolution kernel is equivalent to a weight parameter connected to corresponding local pixels. The parameters in the convolution kernel are multiplied with the corresponding local pixel values, and then added with an offset parameter, to obtain a convolution result. A specific calculation formula is shown as follows: fᵢⱼ^{k}=relu((w^{k}*x)ᵢⱼ+bₖ), wherein f^{k} denotes the kth characteristic result chart, relu(x)=max (0,x), W^{k} denotes a parameter of the th convolution kernel, x denotes a characteristic of an upper layer, and b^{k} is the offset parameter.

In an embodiment of the present invention, max[s2] is used to denote a pooling layer having a step length of s2. The input characteristic chart is compressed, such that the characteristic chart becomes smaller, the complexity in network computing is reduced, and major characteristics of the input characteristic chart are extracted. Therefore, it is necessary to carry out pooling processing on the characteristic chart output by the convolutional layer, to reduce the degree of overfitting of the training parameters and the training model of the spatial transformer network. Commonly used pooling methods include max pooling and average pooling. The max pooling is selecting the maximum value in a pooling window to serve as a pooled value. The average pooling is selecting an average value in a pooling region to serve as a pooled value. The max pooling is used in an embodiment of the present invention.

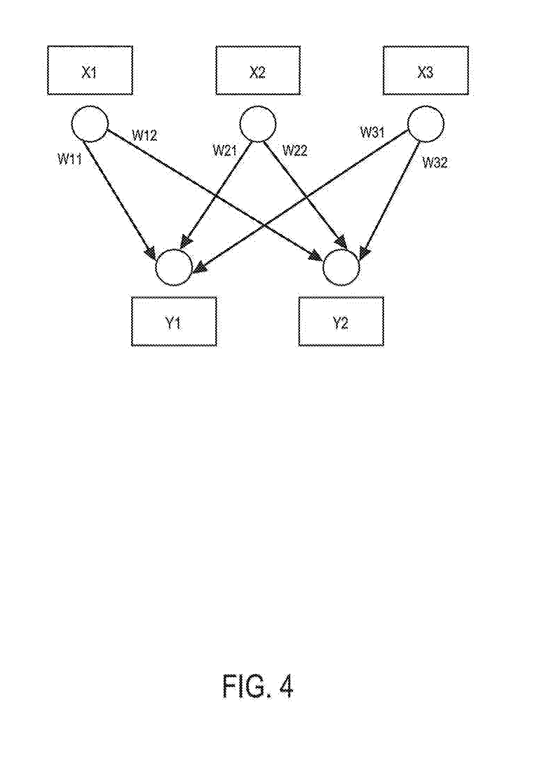

In an embodiment of the present invention, fc[R] is used to denote a fully connected layer including R output units. Nodes of any two adjacent fully connected layers are connected to each other. The number of input neurons (i.e., the characteristic chart) of any fully connected layer may be identical to or different from the number of output neurons. If the any fully connected layer is not the last fully connected layer, the input neurons and output neurons of the any fully connected layer are the characteristic chart. For example, please refer to FIG. 4, a schematic diagram of converting three input neurons into two output neurons by carrying out dimensionality reduction processing using a fully connected layer according to an embodiment of the present invention. A specific conversion formula is shown as follows:

$$( X 1 , X 2 , X 3 ) * ( \begin{matrix}{W}_{11} & {W}_{12} \\ {W}_{21} & {W}_{22} \\ {W}_{31} & {W}_{32}\end{matrix} ) = ( Y 1 , Y 2 )$$

wherein X1, X2 and X3 are input neurons of the any fully connected layer; Y1 and Y2 are output neurons of the any fully connected layer, Y1=(X1*W11+X2*W21+X3*W31), Y2=(XL*W12+X2*W22+X3*W32); and W is a weight of X1, X2 and X3 in Y1 and Y2. In an embodiment of the present invention, the last fully connected layer in the spatial transformer network includes only two output nodes. Output values of the two output nodes are respectively a probability used for indicating that an image sample is a reproduced identity card image and a probability used for indicating that an image sample is a non-reproduced identity card image.

In an embodiment of the present invention, the positioning network in the spatial transformer module is set to a “conv[32,5,1,2]-max[2]-conv[32,5,1,2]-fc[32]-fc[32]-fc[12]” structure. That is, the first layer is a convolutional layer conv[32,5,1,2], the second layer is a pooling layer max[2], the third layer is a convolutional layer conv[32,5,1,2], the fourth layer is a fully connected layer fc[32], the fifth layer is a fully connected layer fc[32], and the sixth layer is a fully connected layer fc[12].

In an embodiment of the invention, the CNN in the network is set to “conv[48,5,1,21-max[2]-conv[64,5,1,2]-conv[128,5,1,2]-max[2]-conv[160,5,1,2]-conv[192,5,1,2]-max[2]-conv[192,5,1,2]-conv[192,5,1,2]-max[2]-conv[192,5,1,2]-fc(3072]-fc[3072]-fc[2]”. That is, the first layer is a convolutional layer conv[48,5,1,2], the second layer is a pooling layer max[2], the third layer is a convolutional layer conv[64,5,1,2], the fourth layer is a convolutional layer conv[128,5,1,2], the fifth layer is a pooling layer max[2], the sixth layer is a convolutional layer conv[160,5,1,2], the seventh layer is a convolutional layer conv[192,5,1,2], the eighth layer is a pooling layer max[2], the ninth layer is a convolutional layer conv[192,5,1,2], the tenth layer is a convolutional layer conv[192,5,1,2], the eleventh layer is a pooling layer max[2], the twelfth layer is a convolutional layer conv[192,5,1,2], the thirteenth layer is a fully connected layer fc[3072], the fourteenth layer is a fully connected layer fc[3072], and the fifteenth layer is a fully connected layer fc[2].

Further, in an embodiment, a softmax classifier is connected behind the last fully connected layer in the spatial transformer network, and a loss function thereof is shown as follows:

$$J ( θ ) = - \frac{1}{m} [ {\sum }_{i = 1}^{m} {\sum }_{j = 1}^{k} 1 ( {y}^{( i )} = j ) log \frac{{x}^{j}}{{\sum }_{l = 1}^{k} {x}^{j}} ] ,$$

wherein m is the number of training samples; xⱼ is an output of the j^{th} node in the fully connected layer; y⁽ⁱ⁾ is a tag class of the i^{th} sample, when y⁽ⁱ⁾ equals to j; a value of 1(y⁽ⁱ⁾=j) being 1; otherwise, the value being 0, θ is a parameter of the network, and J is a loss function value.

Step 120: Model training is carried out on the spatial transformer network based on the training set. The so-called model training carried out on the spatial transformer network is actively carrying out recognition and judgment on input image samples and adjusting parameters correspondingly according to a recognition accuracy rate during automatic learning of the spatial transformer network based on the training set, such that a recognition result for a subsequently input image sample is more accurate.

In an embodiment of the present invention, the spatial transformer network model is trained by using a stochastic gradient descent (SGD) method. A specific implementation is described as follows:

First, the image samples included in the training set are divided into several batches based on the spatial transformer network, wherein one batch includes G image samples, and G is a positive integer greater than or equal to 1. Each image sample is a confirmed reproduced identity card image or a confirmed non-reproduced identity card image.

Then, the following operations are performed sequentially for each batch included in the training set by using the spatial transformer network: carrying out spatial transformation processing and image processing on each image sample included in one batch by using current configuration parameters and obtaining a corresponding recognition result, wherein the configuration parameters include at least a parameter used by at least one convolutional layer, a parameter used by at least one pooling layer, a parameter used by at least one fully connected layer, and a parameter used by the spatial transformer module; calculating a recognition accuracy rate corresponding to the one batch based on recognition results of image samples included in the one batch; and judging whether the recognition accuracy rate corresponding to the one batch is greater than a first preset threshold; if so, keeping the current configuration parameters unchanged; otherwise, adjusting the current configuration parameters, and using the adjusted configuration parameters as current configuration parameters used for a next batch.

In an embodiment of the present invention, the image processing may certainly include, but is not limited to, appropriate image sharpening processing and the like carried out on the image to the edge, contour, and details of the image clearer. The spatial transformation processing may include, but is not limited to, any one or a combination of the following operations: rotation processing, translation processing, and scaling processing.

Until it is judged that all the recognition accuracy rates corresponding to Q successive batches are greater than the first preset threshold, the model training carried out on the spatial transformer network can be determined as finished, and Q is a positive integer greater than or equal to 1.

As can be appreciated, in an embodiment of the present invention, the current configuration parameters are preset initial configuration parameters for the first batch in the training set; preferably, initial configuration parameters are randomly generated by the spatial transformer network. For a batch other than the first batch, the current configuration parameters are configuration parameters used for a previous batch; or adjusted configuration parameters obtained after adjustment is carried out on the basis of the configuration parameters used for a previous batch.

Preferably, the specific process of performing a training operation on each batch of image sample subset in the training set based on the spatial transformer network is described as follows:

In an embodiment of the present invention, the last fully connected layer in the spatial transformer network includes two output nodes. Output values of the two output nodes are respectively a probability indicating that an image sample is a reproduced identity card image and a probability indicating that an image sample is a non-reproduced identity card image. When it is judged that, for a non-reproduced identity card image, an output probability indicating that the image sample is a non-reproduced identity card image is greater than or equal to 0.95 and an output probability indicating that the image sample is a reproduced identity card image is less than or equal to 0.05, the recognition is determined as correct. When it is judged that, for a reproduced identity card image, an output probability indicating that the image sample is a reproduced identity card image is greater than or equal to 0.95 and an output probability indicating that the image sample is a non-reproduced identity card image is less than or equal to 0.05, the recognition is determined as correct. For any image sample, a sum of the probability indicating that the image sample is a reproduced identity card image and the probability indicating that the image sample is a non-reproduced identity card image is 1. In an embodiment of the present invention, 0.95 and 0.05 are used merely as examples; and other thresholds may certainly be set in actual embodiments according to operation and maintenance experiences, which will not be described in detail here.

After image samples included in any batch of image sample subset are recognized, the number of correctly recognized image samples included in the any batch of image sample sub-set is counted, and the recognition accuracy rate corresponding to the any batch of image sample sub-set is calculated.

In an embodiment, each image sample included in the first batch of image sample sub-set (briefly referred to as the first batch) in the training set may be recognized respectively based on preset initial configuration parameters, and a recognition accuracy rate corresponding to the first batch is obtained through calculation. The preset initial configuration parameters are configuration parameters set based on the spatial transformer network. For example, the configuration parameters include at least a parameter used by at least one convolutional layer, a parameter used by at least one pooling layer, a parameter used by at least one fully connected layer, and a parameter used in the spatial transformer.

For example, assuming that initial parameters are set for 256 image samples included in the first batch in the training set; the characteristics of the 256 image samples included in the first batch are extracted respectively; and the 256 image samples included in the first batch are recognized respectively by using the spatial transformer network to obtain a recognition result of each of the image samples. A recognition accuracy rate corresponding to the first batch is calculated based on the recognition results.

Then, each image sample included in the second batch of image sample subset (briefly referred to as the second batch) is recognized respectively. In an embodiment, if it is judged that the recognition accuracy rate corresponding to the first batch is greater than the first preset threshold, the image samples included in the second batch are recognized by using the initial configuration parameters preset for the first batch; and a recognition accuracy rate corresponding to the second batch is obtained. If it is judged that the recognition accuracy rate corresponding to the first batch is not greater than the first preset threshold, configuration parameter adjustment is carried out on the initial configuration parameters preset for the first batch, so as to obtain the adjusted configuration parameters; and the image samples included in the second batch are recognized by using the adjusted configuration parameters to obtain a recognition accuracy rate corresponding to the second batch.

Likewise, related processing may be carried out on image sample subsets of the third batch, the fourth batch, and so on by using the same manner continuously, till all image samples in the training set are processed.

In brief, during training, starting from the second batch in the training set, if it is judged that the recognition accuracy rate corresponding to the previous batch is greater than the first preset threshold, the image samples included in the current batch are recognized by using configuration parameters corresponding to the previous batch; and a recognition accuracy rate corresponding to the current batch is obtained. If it is judged that the recognition accuracy rate corresponding to the previous batch is not greater than the first preset threshold, parameter adjustment is carried out based on the configuration parameters corresponding to the previous batch, so as to obtain the adjusted configuration parameters; and the image samples included in the current batch are recognized by using the adjusted configuration parameters, to obtain a recognition accuracy rate corresponding to the current batch.

Further, during model training carried out on the spatial transformer network based on the training set, when it is judged that all recognition accuracy rates of Q successive batches are greater than the first preset threshold after the spatial transformer network uses a set of configuration parameters, and Q is a positive integer greater than or equal to 1, the model training carried out on the spatial transformer network is determined as finished. In this case, it is determined to carry out subsequent model testing procedures by using configuration parameters finally set in the spatial transformer network.

After the model training carried out on the spatial transformer network based on the training set is determined as finished, model testing may be carried out on the spatial transformer network based on the testing set. Moreover, a first threshold corresponding to a false positive rate (FPR) of reproduced identity card image equal to a second preset threshold (e.g., 1%) is determined according to an output result corresponding to each image sample included in the testing set. The first threshold is a value of the probability indicating that the image sample is a reproduced identity card image in the output result.

During model testing carried out on the spatial transformer network, each image sample included in the testing set corresponds to one output result. The output result includes a probability indicating that the image sample is a reproduced identity card image and a probability indicating that the image sample is a non-reproduced identity card image. Values of the probability indicating that the image sample is a reproduced identity card image in different output results correspond to different FPRs. In an embodiment of the present invention, a value of the probability, indicating that the image sample is a reproduced identity card image, corresponding to the FPR equaling to the second preset threshold (e.g., 1%) is determined as the first threshold.

Preferably, in an embodiment of the present invention, during model testing carried out on the spatial transformer network based on the testing set, a receiver operating characteristic (ROC) curve is drawn according to the output results corresponding to the image samples included in the testing set. A value of the probability, indicating that the image sample is a reproduced identity card image, corresponding to the FPR equaling to 1% is determined as the first threshold according to the ROC curve.

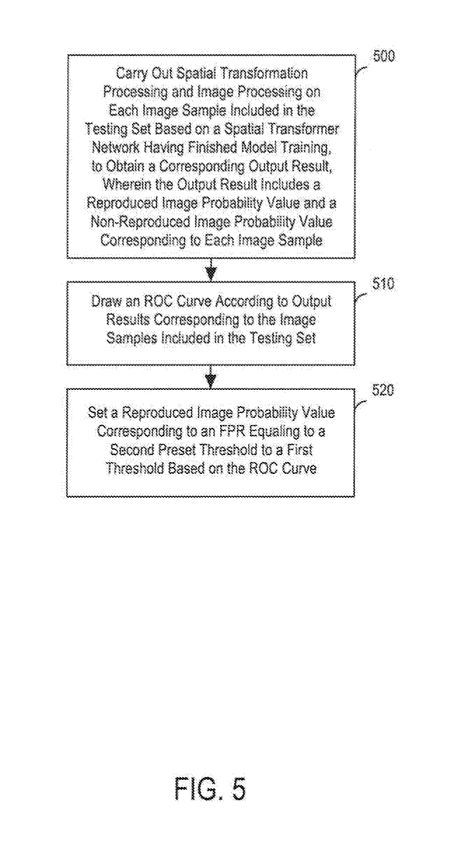

Please refer to FIG. 5. A detailed procedure of carrying out model testing on a spatial transformer network based on the testing set according to an embodiment of the present invention is described as follows:

Step 500: Spatial transformation processing and image processing are carried out on each image sample included in the testing set based on the spatial transformer network having finished the model training, so as to obtain a corresponding output result, wherein the output result includes a reproduced image probability value and a non-reproduced image probability value corresponding to each image sample.

In an embodiment of the present invention, the image samples included in the testing set are used as original images for model testing carried out on the spatial transformer network, and each image sample included in the testing set is acquired respectively. Moreover, when the model training carried out on the spatial transformer network is finished, the acquired each image sample included in the testing set is recognized respectively by using configuration parameters that are set finally in the spatial transformer network.

For example, assuming that the spatial transformer network is set as follows: the first layer is a convolutional layer 1, the second layer is a spatial transformer module, the third layer is a convolutional layer 2, the fourth layer is a pooling layer 1, and the fifth layer is a fully connected layer 1. Then, a specific procedure of carrying out image recognition on any original image x based on the spatial transformer network is described as follows:

The convolutional layer 1 uses the original image x as an input image, carries out sharpening processing on the original image x, and uses the original image x after the sharpening processing is carried out as an output image x1.

The spatial transformer uses the output image x1 as an input image, carries out a spatial transformation operation (e.g., rotating clockwise by 60 degrees and/or translating leftward by 2 cm, and so on) on the output image x1, and uses the rotated and/or translated output image x1 as an output image x2.

The convolutional layer 2 uses the output image x2 as an input image, carries out fuzzy processing on the output image x2, and uses the output image x2 after the fuzzy processing is carried out as an output image x3.

The pooling layer 1 uses the output image x3 as an input image, carries out compression processing on the output image x3 by using max pooling, and uses the compressed output image x3 as an output image x4.

The last layer of the spatial transformer network is the fully connected layer 1. The fully connected layer 1 uses the output image x4 as an input image, and carries out classification processing on the output image x4 based on a characteristic chart of the output image x4. The fully connected layer 1 includes two output nodes (e.g., a and b), wherein a indicates a probability of the original image x being a reproduced identity card image, and b indicates a probability of the original image x being a non-reproduced identity card image. For example, a=0.05, and b=0.95.

Then, a first threshold is set based on the output result, thereby determining that the model testing carried out on the spatial transformer network is finished.

With reference to Step 510, an ROC curve is drawn according to the output results corresponding to the image samples included in the testing set.

In an embodiment of the present invention, a respective reproducing probability value of each image sample included in the testing set is used as a set threshold; an FPR and a true positive rate (TPR) corresponding to each set threshold are determined based on the reproduced image probability value and the non-reproduced image probability value corresponding to each image sample included in the output result. An ROC curve is drawn based on the determined FPR and TPR corresponding to each set threshold, the ROC curve using the FPR as an X-axis and the TPR aY-axis.

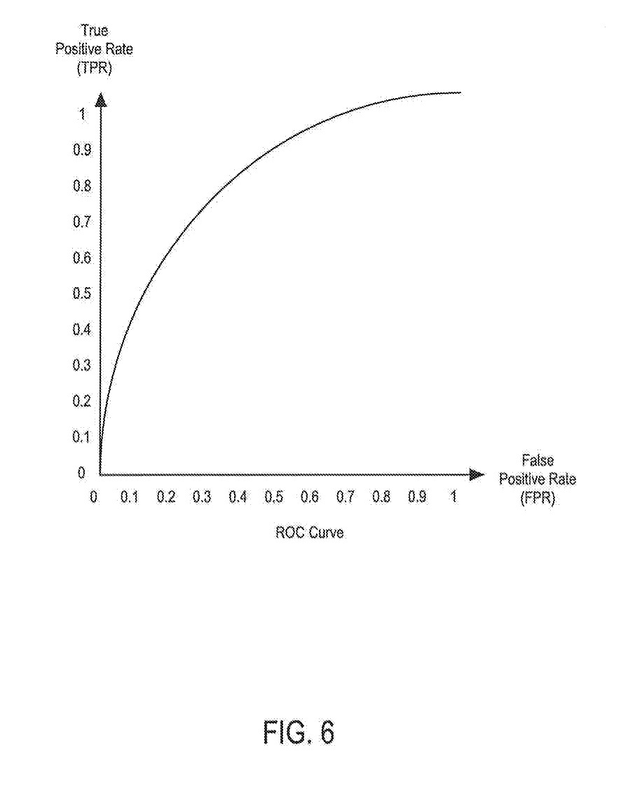

For example, assuming that the testing set includes ten image samples, and each image sample included in the testing set corresponds to a probability used for indicating that the image sample is a reproduced identity card image and a probability used for indicating that the image sample is a non-reproduced identity card image. For any image sample, a sum of the probability used for indicating that the image sample is a reproduced identity card image and the probability used for indicating that the image sample is a non-reproduced identity card image is 1. In an embodiment of the present invention, different values of the probability used for indicating that the image sample is a reproduced identity card image correspond to different FPRs and TPRs. As a result, ten values of the probability, used for indicating that the image sample is a reproduced identity card image, corresponding to the ten image samples included in the testing set may be used as set thresholds respectively. An FPR and a TPR corresponding to each set threshold are determined based on a probability value used for indicating that the image sample is a reproduced identity card image and a probability value used for indicating that the image sample is a non-reproduced identity card image corresponding to each of the ten image samples included in the testing set. Please refer to FIG. 6, illustrating a schematic diagram of drawing an ROC curve based on 10 groups of different FPRs and TPRs according to an embodiment of the present invention; the ROC curve using the FPR as an X-axis and the TPR as a Y-axis.

With reference to Step 520, a reproduced image probability value corresponding to the FPR equaling to a second preset threshold is set to a first threshold based on the ROC curve.

For example, assuming that in an embodiment of the present invention, after the ROC curve is drawn, if it is judged that a value of a probability, used for indicating that an image sample is a reproduced identity card image, corresponding the FPR equaling to 1% is 0.05, the first threshold is set to 0.05.

In an embodiment of the present invention, 0.05 is merely used as an example; and other first thresholds may certainly be set in actual embodiments according to operation and maintenance experiences, which will not be described in detail here.

In an embodiment of the present invention, after the model training carried out on the established spatial transformer network based on the training set is finished and the model testing carried out on the spatial transformer network based on the testing set is finished, it is determined that establishment of the spatial transformer network model is finished, and a threshold (e.g., T) when the spatial transformer network model is used actually is determined. Moreover, when the spatial transformer network model is used actually, a magnitude relationship between a value T′ of a probability and T is judged, the probability being obtained after recognition processing is carried out on an input image by the spatial transformer network model and used for indicating that an image sample is a reproduced identity card image. A corresponding subsequent operation is carried out according to the magnitude relationship between T′ and T.

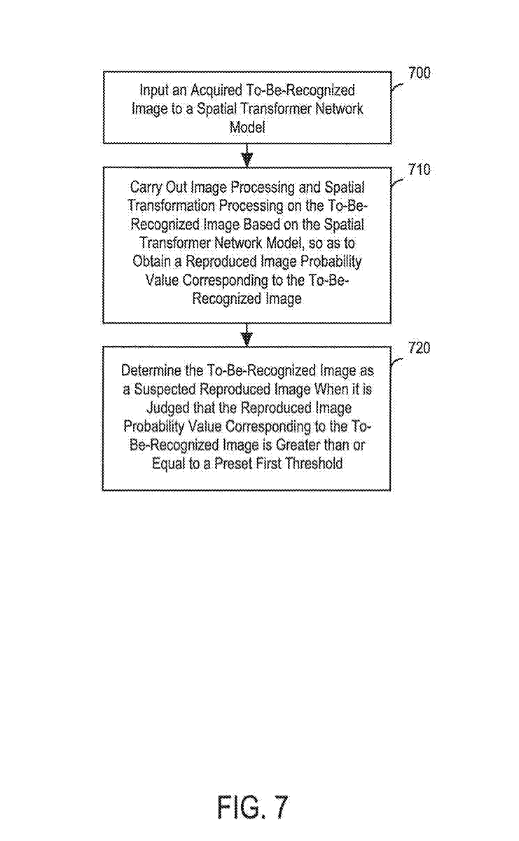

Please refer to FIG. 7, illustrating a detailed procedure of carrying out image recognition by using a spatial transformer network model online according to an embodiment of the present embodiments is described as follows:

With reference to Step 700, an acquired to-be-recognized image is input to a spatial transformer network model.

In an embodiment, after model training carried out on a spatial transformer network based on image samples included in a training set is finished, and model testing carried out on the spatial transformer network having finished the model training based on image samples included in a testing set is finished, a spatial transformer network model is obtained. The spatial transformer network model can carry out image recognition on a to-be-recognized image input to the model.

For example, assuming that the acquired to-be-recognized image is an identity card image of Li, and then, the acquired identity card image of Li is input to the spatial transformer network model.

Step 710: Image processing and spatial transformation processing are carried out on the to-be-recognized image based on the spatial transformer network model so as to obtain a reproduced image probability value corresponding to the to-be-recognized image.

In an embodiment, the spatial transformer network model includes at least a CNN and a spatial transformer. The spatial transformer includes at least a positioning network, a grid generator, and a sampler. At least once convolution processing, at least once pooling processing, and at least once full connection processing are carried out on the to-be-recognized image based on the spatial transformer network model.

For example, assuming that the spatial transformer network model includes the CNN and the spatial transformer module, and the spatial transformer includes at least a positioning network 1, a grid generator 1, and a sampler 1. The CNN is set to include a convolutional layer 1, a convolutional layer 2, a pooling layer 1, and a fully connected layer 1. Then, twice convolution processing, once pooling processing, and once full connection processing are carried out on the identity card image of Li input to the spatial transformer network model.

Further, the spatial transformer is set behind any convolutional layer in the CNN included in the spatial transformer network model. Then, after any convolution processing is carried out on the to-be-recognized image by using the CNN, a transformation parameter set is generated by using the positioning network, sampling grids are generated by using the grid generator according to the transformation parameter set, and sampling and spatial transformation processing are carried out on the to-be-recognized image by using the sampler according to the sampling grids. The spatial transformation processing includes at least any one or a combination of the following operations: rotation processing, translation processing, and scaling processing.

For example, assuming that the spatial transformer is set behind the convolutional layer 1 and before the convolutional layer 2. Then, after convolution processing is carried out once, by using the convolutional layer 1, on the identity card image of Li input to the spatial transformer network model, the identity card image of Li is rotated clockwise by 30 degrees and/or translated leftward by 2 cm and so on by using a transformation parameter set generated by using a location 1 included in the spatial transformer.

Step 720: The to-be-recognized image is determined as a suspected reproduced image when it is judged that the reproduced image probability value corresponding to the to-be-recognized image is greater than or equal to a preset first threshold.

For example, assuming that during image recognition carried out on an original image y by using the spatial transformer network model, the spatial transformer network model uses the original image y as an input image, and carries out corresponding sharpening processing, spatial transformation processing (e.g., rotating anticlockwise by 30 degrees and/or translating leftward by 3 cm, and so on), fuzzy processing, and compression processing on the original image y. After that, the last layer (fully connected layer) of the spatial transformer network model carries out classification processing. The last layer, i.e., the fully connected layer includes two output nodes. The two output nodes are respectively a value T′ of a probability used for indicating that the original image y is a reproduced identity card image, and a value of a probability used for indicating that the original image y is a non-reproduced identity card image. Further, the value T′ of the probability, used for indicating that the original image y is a reproduced identity card image, obtained after recognition processing is carried out on the original image y by using the spatial transformer network model is compared with the first threshold T determined during model testing carried out on the spatial transformer network. If T′<T, the original image y is determined as a non-reproduced identity card image, that is, a normal image. If T′≥T, the original image y is determined as a reproduced identity card image.

Further, when it is judged that T′≥t, the original image y is determined as a suspected reproduced identity card image, and the procedure proceeds to a manual reviewing stage. During the manual reviewing state, if it is judged that the original image y is a reproduced identity card image, the original image y is determined as a reproduced identity card image. During the manual reviewing stage, if it is judged that the original image y is a non-reproduced identity card image, the original image y is determined as a non-reproduced identity card image.

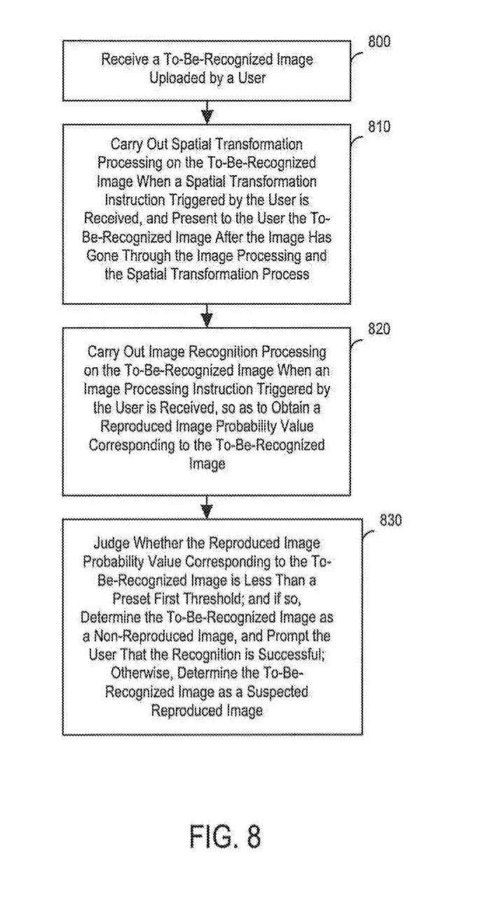

An embodiment of the present invention in an actual business scenario will be described in detail in the following. Please refer to FIG. 8 illustrating a detailed procedure of carrying out image recognition processing on a to-be-recognized image according to an embodiment of the present invention is described as follows:

Step 800: A to-be-recognized image uploaded by a user is received.

For example, assuming that Zhang carries out real-person authentication on an e-commerce platform, and then, Zhang needs to upload an identity card image thereof to the e-commerce platform to carry out real-person authentication. The e-commerce platform receives the identity card image uploaded by Zhang.

Step 810: Image processing is carried out on the to-be-recognized image when an image processing instruction triggered by the user is received, spatial transformation processing is carried out on the to-be-recognized image when a spatial transformation instruction triggered by the user is received, and the to-be-recognized image after the image processing and the spatial transformation processing are carried out is presented to the user.

In an embodiment, when the image processing instruction triggered by the user is received, at least once convolution processing, at least once pooling processing, and at least once full connection processing are carried out on the to-be-recognized image.

In an embodiment, after the to-be-recognized original image uploaded by the user is received, assuming that after convolution processing, e.g., image sharpening processing, is carried out on the to-be-recognized original image once, the sharpened to-be-recognized image having clearer edge, contour, and details of the image may be obtained.

For example, assuming that Zhang uploads the identity card image thereof to the e-commerce platform, and then the e-commerce platform may present, to Zhang by using a terminal, whether image processing (e.g., convolution processing, pooling processing, and fully connected processing) is carried out on the identity card image. When receiving an instruction for carrying out image processing on the identity card image triggered by Zhang, the e-commerce platform carries out sharpening processing and compression processing on the identity card image.

After a spatial transformation instruction triggered by the user is received, any one or a combination of the following operations is carried out on the to-be-recognized image: rotation processing, translation processing, and scaling processing.

In an embodiment of the present invention, after the spatial transformation instruction triggered by the user is received, assuming that rotation processing and translation processing are carried out on the image after the sharpening processing is carried out, the corrected to-be-recognized image may be obtained.

For example, assuming that Zhang uploads the identity card image thereof to the e-commerce platform. Then the e-commerce platform may present, to Zhang by using the terminal, whether rotation processing and/or translation processing is carried out on the identity card image. When receiving an instruction for carrying out rotation processing and/or translation processing on the identity card image triggered by Zhang, the e-commerce platform rotates the identity card image clockwise by 60 degrees and then translates the identity card image leftward by 2 cm, to obtain the rotated and translated identity card image.

In an embodiment of the present invention, after sharpening processing, rotation processing, and translation processing are carried out on the to-be-recognized image, the to-be-recognized image after the sharpening processing, rotation processing, and translation processing are carried out is presented to the user by using the terminal.

With reference to Step 820, a reproduced image probability value corresponding to the to-be-recognized image is calculated according to a user instruction.

For example, assuming that the e-commerce platform presents, to Zhang by using the terminal, the identity card image of Zhang after the image processing and spatial transformation processing are carried out, and prompts Zhang whether to calculate a reproduced image probability value corresponding to the identity card image. The e-commerce platform calculates the reproducing probability value corresponding to the identity card image when receiving the instruction for calculating the reproduced image probability value corresponding to the identity card image triggered by Zhang.

With reference to Step 830, it is judged whether the reproduced image probability value corresponding to the to-be-recognized image is less than a preset first threshold; and if so, the to-be-recognized image is determined as a non-reproduced image, and the user is prompted that the recognition is successful; otherwise, the to-be-recognized image is determined as a suspected reproduced image.

Further, when the to-be-recognized image is determined as the suspected reproduced image, the suspected reproduced image is presented to an administrator; and the administrator is prompted to review the suspected reproduced image. It is determined whether the suspected reproduced image is a reproduced image according to a review feedback of the administrator.

An embodiment is further illustrated in detail by using a specific scenario in as follows:

For example, after receiving an identity card image uploaded by a user for carrying out real-person authentication, a computing device carries out image recognition by using the identity card image as an original input image, to judge whether the identity card image uploaded by the user is a reproduced identity card image, thereby performing a real-person authentication operation. In an embodiment, when receiving an instruction for carrying out sharpening processing on the identity card image triggered by the user, the computing device carries out corresponding sharpening processing on the identity card image. After the sharpening processing is carried out on the identity card image, according to an instruction for carrying out spatial transformation processing (e.g., processing such as rotation and translation) on the identity card image triggered by the user, the computing device carries out corresponding rotation and/or translation processing on the identity card image after the sharpening processing is carried out. Then, the computing device carries out corresponding fuzzy processing on the identity card image after the spatial transformation processing is carried out. Next, the computing device carries out corresponding compression processing on the identity card image after the fuzzy processing is carried out. Finally, the computing device carries out corresponding classification processing on the identity card image after the compression processing is carried out, to obtain a probability value corresponding to the identity card image and used for indicating that the identity card image is a reproduced image. When it is judged that the probability value meets a preset condition, the identity card image uploaded by the user is determined as a non-reproduced image, and the user is prompted that the real-person authentication is successful. When it is judged that the probability value does not meet the preset condition, the identity card image uploaded by the user is determined as a suspected reproduced image, and the suspected reproduced identity card image is transferred to a administrator for subsequent manual reviewing. In the manual reviewing stage, if the administrator judges the identity card image uploaded by the user as a reproduced identity card image, the user is prompted that the real-person authentication is failed, and it is necessary to upload a new identity card image. If the administrator judges the identity card image uploaded by the user as a non-reproduced identity card image, the user is prompted that the real-person authentication is successful.

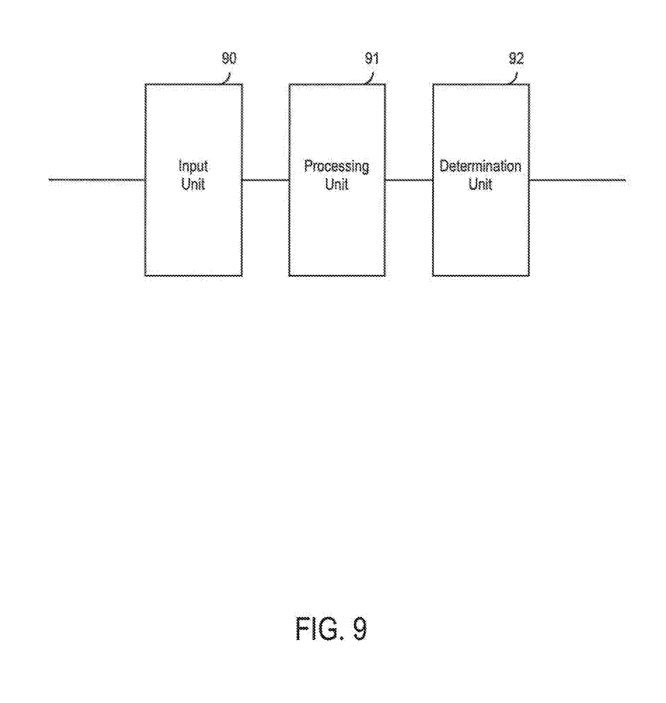

Based on the above embodiments, please now refer to FIG. 9. In an embodiment of the present invention, an image recognition apparatus includes at least an input unit 90, a processing unit 91, and a determination unit 92.

The input unit 90 is configured to input an acquired to-be-recognized image to a spatial transformer network model.

The processing unit 91 is configured to carry out image processing and spatial transformation processing on the to-be-recognized image based on the spatial transformer network model so as to obtain a reproduced image probability value corresponding to the to-be-recognized image.

The determination unit 92 is configured to determine the to-be-recognized image as a suspected reproduced image when it is judged that the reproduced image probability value corresponding to the to-be-recognized image is greater than or equal to a preset first threshold.

In an embodiment, before an acquired to-be-recognized image is input to a spatial transformer network model, the input unit 90 is further configured to: acquire image samples, and divide the acquired image samples into a training set and a testing set according to a preset ratio; and construct a spatial transformer network based on a convolutional neural network (CNN) and a spatial transformer module, carry out a model training on the spatial transformer network based on the training set, and carry out a model testing on the spatial transformer network with the model training finished based on the testing set.

In an embodiment, when a spatial transformer network is constructed based on a CNN and a spatial transformer module, the input unit 90 is configured to: embed a learnable spatial transformer in the CNN to construct the spatial transformer network, wherein the spatial transformer includes at least a positioning network, a grid generator, and a sampler, the positioning network including at least one convolutional layer, at least one pooling layer, and at least one fully connected layer, wherein the positioning network is configured to generate a transformation parameter set; the grid generator is configured to generate sampling grids according to the transformation parameter set; and the sampler is configured to sample the input image according to the sampling grids.

In an embodiment, when carrying out a model training on the spatial transformer network based on the training set, the input unit 90 is configured to: divide the image samples included in the training set into several batches based on the spatial transformer network, wherein one batch includes G image samples, and G is a positive integer greater than or equal to 1; and sequentially perform the following operations for each batch included in the training set until it is judged that all recognition accuracy rates corresponding to Q successive batches are greater than a first preset threshold; determine that the model training carried out on the spatial transformer network is finished, and Q is a positive integer greater than or equal to 1; carry out spatial transformation processing and image processing on each image sample comprised in one batch by using current configuration parameters and obtain a corresponding recognition result, wherein the configuration parameters comprise at least a parameter used by at least one convolutional layer, a parameter used by at least one pooling layer, a parameter used by at least one fully connected layer, and a parameter used by the spatial transformer module; calculate a recognition accuracy rate corresponding to the one batch based on recognition results of the image samples included in the one batch; and judge whether the recognition accuracy rate corresponding to the one batch is greater than the first preset threshold; and if so, keep the current configuration parameters unchanged; otherwise, adjust the current configuration parameters, and use the adjusted configuration parameters as current configuration parameters used for a next batch.

In an embodiment, when model testing is carried out on the spatial transformer network having finished the model training based on the testing set, the input unit 90 is configured to: carry out image processing and spatial transformation processing on each image sample included in the testing set based on the spatial transformer network having finished the model training, so as to obtain a corresponding output result, wherein the output result includes a reproduced image probability value and a non-reproduced image probability value corresponding to each image sample; and set the first threshold based on the output result, thereby determining that the model testing carried out on the spatial transformer network is finished.

In an embodiment, when the first threshold is set based on the output result, the input unit 90 is configured to: use a respective reproducing probability value of each image sample included in the testing set as a set threshold; and determine a false positive rate (FPR) and a true positive rate (TPR) corresponding to each set threshold based on the reproduced image probability value and the non-reproduced image probability value corresponding to each image sample included in the output result; draw a receiver operating characteristic (ROC) curve based on the determined FPR and TPR corresponding to each set threshold, the ROC curve using the FPR as an X-axis and the TPR as a Y-axis; and set a reproduced image probability value corresponding to the FPR equaling to a second preset threshold as the first threshold based on the ROC curve.

In an embodiment, when carrying out image processing on the to-be-recognized image based on the spatial transformer network model, the input unit 90 is configured to: carry out convolution processing at least once, pooling processing at least once, and full connection processing at least once on the to-be-recognized image based on the spatial transformer network model.

In an embodiment, when carrying out spatial transformation processing on the to-be-recognized image, the input unit 90 is configured to: the spatial transformer network model including at least the CNN and the spatial transformer module, and the spatial transformer module including at least the positioning network, the grid generator, and the sampler; after any convolution processing is carried out on the to-be-recognized image by using the CNN, generate the transformation parameter set by using the positioning network; generate the sampling grids by using the grid generator according to the transformation parameter set; and carry out sampling and spatial transformation processing on the to-be-recognized image by using the sampler according to the sampling grids, wherein the spatial transformation processing includes at least any one or a combination of the following operations: rotation processing, translation processing, and scaling processing.

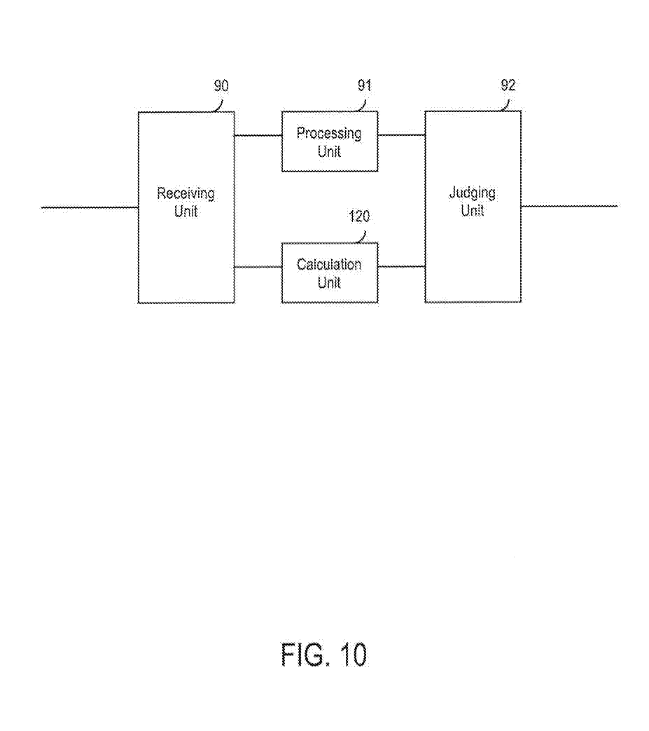

Please refer to FIG. 10. In an embodiment of the present invention, an image recognition apparatus includes at least a receiving unit 100, a processing unit 110, a calculation unit 120, and a judging unit 130.

The receiving unit 100 is configured to receive a to-be-recognized image uploaded by a user.

The processing unit 110 is configured to carry out image processing on the to-be-recognized image when an image processing instruction triggered by the user is received; carry out spatial transformation processing on the to-be-recognized image when a spatial transformation instruction triggered by the user is received; and present to the user the to-be-recognized image after the image has gone through the image processing and the spatial transformation processing.

The calculation unit 120 is configured to calculate a reproduced image probability value corresponding to the to-be-recognized image according to a user instruction.

The judging unit 130 is configured to judge whether the reproduced image probability value corresponding to the to-be-recognized image is less than a preset first threshold; and if so, determine the to-be-recognized image as a non-reproduced image, and prompt the user that the recognition is successful; otherwise, determine the to-be-recognized image as a suspected reproduced image.

In an embodiment, after the to-be-recognized image is determined as a suspected reproduced image, the judging unit 130 is further configured to: present the suspected reproduced image to an administrator, and prompt the administrator to review the suspected reproduced image; and determine whether the suspected reproduced image is a reproduced image according to a review feedback of the administrator.

In an embodiment, when image processing is carried out on the to-be-recognized image, the processing unit 110 is configured to: carry out convolution processing at least once, pooling processing at least once, and full connection processing at least once on the to-be-recognized image.

In an embodiment, when spatial transformation processing is carried out on the to-be-recognized image, the processing unit 110 is configured to: carry out any one or a combination of the following operations on the to-be-recognized image: rotation processing, translation processing, and scaling processing.

In view of the above, in embodiments of the present invention, during image recognition based on a spatial transformer network model, an acquired to-be-recognized image is inputted to the spatial transformer network model; image processing and spatial transformation processing are carried out on the to-be-recognized image based on the spatial transformer network model so as to obtain a reproduced image probability value corresponding to the to-be-recognized image; and the to-be-recognized image is determined as a suspected reproduced image when it is judged that the reproduced image probability value corresponding to the to-be-recognized image is greater than or equal to a preset first threshold. By means of the image recognition method, a spatial transformer network model can be established by carrying out model training and model testing on a spatial transformer network only once. In this way, the workload for calibrating image samples during training and testing is reduced, and training and testing efficiencies are improved. Further, the model training is carried out based on a one-level spatial transformer network, and configuration parameters obtained by the training form an optimal combination, thereby improving the recognition effect when an image is recognized by using the spatial transformer network model online.

Those skilled in the art should understand that, embodiments of the present invention may be provided as a method, a system, or a computer program product. Therefore, the present invention may be implemented as a complete hardware embodiment, a complete software embodiment, or an embodiment combining software and hardware. Moreover, the present invention may be in the form of a computer program product implemented on one or more computer usable storage media (including, but not limited to, a magnetic disk memory, a CD-ROM, an optical memory and the like) including computer usable program codes.

The present invention is described with reference to flowcharts and/or block diagrams according to the method, device (system) and computer program product according to embodiments of the present invention. It should be understood that a computer program instruction may be used to implement each process and/or block in the flowcharts and/or block diagrams and combinations of processes and/or blocks in the flowcharts and/or block diagrams. These computer program instructions may be provided for a general-purpose computer, a special-purpose computer, an embedded processor, or a processor of any other programmable data processing device to generate a machine, so that the instructions executed by a computer or a processor of any other programmable data processing device generate an apparatus for implementing a specified function in one or more processes in the flowcharts and/or in one or more blocks in the block diagrams.

These computer program instructions may also be stored in a computer readable memory that can instruct the computer or any other programmable data processing device to work in a particular manner, such that the instructions stored in the computer readable memory generate an artifact that includes an instruction apparatus. The instruction apparatus implements a specified function in one or more processes in the flowcharts and/or in one or more blocks in the block diagrams as disclosed herein.

These computer program instructions may also be loaded onto a computer or another programmable data processing device, such that a series of operation steps are performed on the computer or another programmable device, thereby generating computer-implemented processing. Therefore, the instructions executed on the computer or another programmable device provide steps for implementing a specified function in one or more processes in the flowcharts and/or in one or more blocks in the block diagrams.

Although preferred embodiments of the present invention have been described and claimed, those skilled in the art can make other variations and modifications based on these embodiments based upon their teachings. Therefore, the appended claims include all such embodiments and variations falling within the scope of the present claims

What is claimed is:

1. An image recognition method, comprising:
acquiring a to-be-recognized image;
carrying out spatial transformation processing on the to-be-recognized image based on a spatial transformer network model so as to obtain a reproduced image probability value corresponding to the to-be-recognized image; and
determining the to-be-recognized image as a suspected reproduced image when it is judged that the reproduced image probability value corresponding to the to-be-recognized image is greater than or equal to a preset first threshold.

2. The method of claim 1, wherein before the step of acquiring a to-be-recognized image, the method further comprises:
acquiring image samples, and dividing the acquired image samples into a training set and a testing set according to a preset ratio; and
constructing a spatial transformer network based on a convolutional neural network (CNN) and a spatial transformer module, carrying out a model training on the spatial transformer network based on the training set, and carrying out a model testing on the spatial transformer network having finished the model training based on the testing set.

3. The method of claim 2, wherein the step of constructing a spatial transformer network based on a CNN and a spatial transformer module comprises:
embedding a learnable spatial transformer module in the CNN to construct a spatial transformer network, wherein the spatial transformer module comprises at least a positioning network, a grid generator, and a sampler, the positioning network comprising at least one convolutional layer, at least one pooling layer, and at least one fully connected layer,
wherein the positioning network is configured to generate a transformation parameter set; the grid generator is configured to generate sampling grids according to the transformation parameter set; and the sampler is configured to sample the input image according to the sampling grids.

4. The method of claim 2, wherein the step of carrying out a model training on the spatial transformer network based on the training set comprises:
dividing the image samples in the training set into several batches based on the spatial transformer network, wherein one batch comprises G image samples, and G is a positive integer greater than or equal to 1;
sequentially performing the following operations for each batch in the training set until it is judged that all recognition accuracy rates corresponding to Q successive batches are greater than a first preset threshold, determining that the model training carried out on the spatial transformer network is finished, and Q is a positive integer greater than or equal to 1;
carrying out spatial transformation processing and image processing on each image sample in one batch by using current configuration parameters and obtaining a corresponding recognition result, wherein the configuration parameters comprise at least a parameter used by at least one convolutional layer, a parameter used by at least one pooling layer, a parameter used by at least one fully connected layer, and a parameter used by the spatial transformer module;
calculating a recognition accuracy rate corresponding to the one batch based on recognition results of the image samples comprised in the one batch; and
judging whether the recognition accuracy rate corresponding to the one batch is greater than the first preset threshold; if so, keeping the current configuration parameters unchanged; otherwise, adjusting the current configuration parameters, and using the adjusted configuration parameters as current configuration parameters used for a next batch.

5. The method of claim 4, wherein the step of carrying out a model testing on the spatial transformer network having finished the model training based on the testing set comprises:
carrying out image processing and spatial transformation processing on each image sample comprised in the testing set based on the spatial transformer network having finished the model training to obtain a corresponding output result, wherein the output result comprises a reproduced image probability value and a non-reproduced image probability value corresponding to each image sample; and
setting the first threshold based on the output result, thereby determining that the model testing carried out on the spatial transformer network is finished.

6. The method of claim 5, wherein the step of setting the first threshold based on the output result comprises:
using a respective reproducing probability value of each image sample comprised in the testing set as a set threshold, and determining a false positive rate (FPR) and a true positive rate (TPR) corresponding to each set threshold based on the reproduced image probability value and the non-reproduced image probability value corresponding to each image sample in the output result;
drawing a receiver operating characteristic (ROC) curve based on the determined FPR and TPR corresponding to each set threshold, the ROC curve using the FPR as an X-axis and the TPR as a Y-axis; and
setting a reproduced image probability value corresponding to the FPR equaling to a second preset threshold as the first threshold based on the ROC curve.

7. The method of claim 1, wherein the step of carrying out spatial transformation processing on the to-be-recognized image based on the spatial transformer network model comprises:
carrying out convolution processing at least once, pooling processing at least once, and full connection processing at least once on the to-be-recognized image based on the spatial transformer network model.

8. The method of claim 7, wherein the step of carrying out spatial transformation processing on the to-be-recognized image further comprises:
using the spatial transformer network model comprising at least the CNN and the spatial transformer module, and the spatial transformer module comprising at least the positioning network, the grid generator, and the sampler; and
after any convolution processing is carried out on the to-be-recognized image by using the CNN, generating the transformation parameter set by using the positioning network, generating the sampling grids by using the grid generator according to the transformation parameter set, and carrying out sampling and spatial transformation processing on the to-be-recognized image by using the sampler according to the sampling grids,
wherein the spatial transformation processing comprises at least any one or a combination of the following operations: rotation processing, translation processing, and scaling processing.

9. An image recognition method, comprising:
receiving a to-be-recognized image;
carrying out spatial transformation processing on the to-be-recognized image when a spatial transformation instruction triggered by the user is received;
presenting to the user the spatial transformation processing result;
calculating a reproduced image probability value corresponding to the to-be-recognized image according to a user instruction; and
based on the reproduced image probability value, determining the to-be-recognized image as a non-reproduced image or a suspected reproduced image.

10. The method of claim 9, wherein after the step of determining the to-be-recognized image as a suspected reproduced image, the method further comprises:
presenting the suspected reproduced image to an administrator, and prompting the administrator to review the suspected reproduced image; and
determining whether the suspected reproduced image is a reproduced image according to a review feedback of the administrator.

11. The method of claim 9 or 10, wherein the step of spatial transformation processing comprises:
carrying out convolution processing at least once, pooling processing at least once, and full connection processing at least once on the to-be-recognized image.

12. The method of claim 11, wherein the step of carrying out spatial transformation processing on the to-be-recognized image further comprises:
carrying out any one or a combination of the following operations on the to-be-recognized image: rotation processing, translation processing, and scaling processing.

13. An image processing apparatus, comprising:
an input unit, configured to acquire a to-be-recognized image;
a processing unit, configured to carry out spatial transformation processing on the to-be-recognized image based on a spatial transformer network model so as to obtain a reproduced image probability value corresponding to the to-be-recognized image; and
a determination unit, configured to determine the to-be-recognized image as a suspected reproduced image when it is judged that the reproduced image probability value corresponding to the to-be-recognized image is greater than or equal to a preset first threshold.

14. The apparatus of claim 13, wherein before the to-be-recognized image is acquired, the input unit is configured to:
acquire image samples, and divide the acquired image samples into a training set and a testing set according to a preset ratio; and
construct a spatial transformer network based on a convolutional neural network (CNN) and a spatial transformer module, carry out a model training on the spatial transformer network based on the training set, and carry out a model testing on the spatial transformer network having finished the model training based on the testing set.

15. The apparatus of claim 14, wherein when configured to construct a spatial transformer network based on a CNN and a spatial transformer module, the input unit is configured to:
embed a learnable spatial transformer module in the CNN to construct a spatial transformer network, wherein the spatial transformer module comprises at least a positioning network, a grid generator, and a sampler, the positioning network comprising at least one convolutional layer, at least one pooling layer, and at least one fully connected layer,
wherein the positioning network is configured to generate a transformation parameter set; the grid generator is configured to generate sampling grids according to the transformation parameter set; and the sampler is configured to sample the input image according to the sampling grids.

16. The apparatus of claim 14, wherein when configured to carry out a model training on the spatial transformer network based on the training set, the input unit is configured to:
divide the image samples comprised in the training set into several batches based on the spatial transformer network, wherein one batch comprises G image samples, and G is a positive integer greater than or equal to 1; and
sequentially perform the following operations for each batch in the training set until it is judged that all recognition accuracy rates corresponding to Q successive batches are greater than a first preset threshold, determine that the model training carried out on the spatial transformer network is finished, and Q is a positive integer greater than or equal to 1;
carry out spatial transformation processing and image processing on each image sample in one batch by using current configuration parameters and obtain a corresponding recognition result, wherein the configuration parameters comprise at least a parameter used by at least one convolutional layer, a parameter used by at least one pooling layer, a parameter used by at least one fully connected layer, and a parameter used by the spatial transformer module;
calculate a recognition accuracy rate corresponding to the one batch based on recognition results of the image samples in the one batch; and
judge whether the recognition accuracy rate corresponding to the one batch is greater than the first preset threshold; and if so, keep the current configuration parameters unchanged; otherwise, adjust the current configuration parameters, and use the adjusted configuration parameters as current configuration parameters used for a next batch.

17. The apparatus of claim 16, wherein when configured to carry out a model testing on the spatial transformer network having finished the model training based on the testing set, the input unit is configured to:
carry out image processing and spatial transformation processing on each image sample in the testing set based on the spatial transformer network having finished the model training to obtain a corresponding output result, wherein the output result comprises a reproduced image probability value and a non-reproduced image probability value corresponding to each image sample; and
set the first threshold based on the output result, thereby determining that the model testing carried out on the spatial transformer network is finished.

18. The apparatus of claim 17, wherein when configured to set the first threshold based on the output result, the input unit is configured to:
use a respective reproducing probability value of each image sample comprised in the testing set as a set threshold, and determine a false positive rate (FPR) and a true positive rate (TPR) corresponding to each set threshold based on the reproduced image probability value and the non-reproduced image probability value corresponding to each image sample comprised in the output result;
draw a receiver operating characteristic (ROC) curve based on the determined FPR and TPR corresponding to each set threshold, the ROC curve using the FPR as an X-axis and the TPR as a Y-axis; and
set a reproduced image probability value corresponding to the FPR equaling to a second preset threshold as the first threshold based on the ROC curve.

19. The apparatus of claim 13, wherein when configured to carry out spatial transformation processing on the to-be-recognized image based on the spatial transformer network model, the processing unit is configured to:
carry out convolution processing at least once, pooling processing at least once, and full connection processing at least once on the to-be-recognized image based on the spatial transformer network model.

20. The apparatus of claim 19, wherein when configured to carry out spatial transformation processing on the to-be-recognized image, the processing unit is configured to:
use the spatial transformer network model comprising at least a CNN and the spatial transformer module, and the spatial transformer module comprising at least the positioning network, the grid generator, and the sampler,
after any convolution processing is carried out on the to-be-recognized image by using the CNN, generate the transformation parameter set by using the positioning network, generate the sampling grids by using the grid generator according to the transformation parameter set, and carry out sampling and spatial transformation processing on the to-be-recognized image by using the sampler according to the sampling grids,
wherein the spatial transformation processing comprises at least any one or a combination of the following operations: rotation processing, translation processing, and scaling processing.

21. An image recognition apparatus, comprising:
a receiving unit, configured to receive a to-be-recognized image uploaded by a user,
a processing unit, configured to carry out image processing on the to-be-recognized image when an image processing instruction triggered by the user is received, carry out spatial transformation processing on the to-be-recognized image when a spatial transformation instruction triggered by the user is received, and present to the user the to-be-recognized image after the image has gone through the image processing and the spatial transformation processing;
a calculation unit, configured to calculate a reproduced image probability value corresponding to the to-be-recognized image according to a user instruction; and
a judging unit, configured to judge whether the reproduced image probability value corresponding to the to-be-recognized image is less than a preset first threshold; and if so, determine the to-be-recognized image as a non-reproduced image, and prompt the user that the recognition is successful; otherwise, determine the to-be-recognized image as a suspected reproduced image.

22. The apparatus of claim 21, wherein after the to-be-recognized image is determined as a suspected reproduced image, the judging unit is further configured to:
present the suspected reproduced image to an administrator, and prompt the administrator to review the suspected reproduced image; and
determine whether the suspected reproduced image is a reproduced image according to a review feedback of the administrator.

23. The apparatus of claim 21 or 22, wherein when configured to carry out image processing on the to-be-recognized image, the processing unit is configured to:
carry out convolution processing at least once, pooling processing at least once, and full connection processing at least once on the to-be-recognized image.

24. The apparatus of claim 23, wherein when configured to carry out spatial transformation processing on the to-be-recognized image, the processing unit is configured to:
carry out any one or a combination of the following operations on the to-be-recognized image: rotation processing, translation processing, and scaling processing.
